(19) United States
(12) Patent Application Publication
(10) Pub. No.: US 2012/0156583 A1
(43) Pub. Date: Jun. 21, 2012

(54) DUAL-MATERIAL CO-INJECTION MOLDED BIPOLAR PLATE AND THE MANUFACTURING METHOD THEREOF

(75) Inventors: Shia-Chung Chen, Taoyuan County (TW); Hsin-Shu Peng, Taoyuan County (TW); Ming-Yi Shih, Taichung County (TW)

(73) Assignee: CHUNG YUAN CHRISTIAN UNIVERSITY, Taoyuan County (TW)

(21) Appl. No.: 13/103,776

(22) Filed: May 9, 2011

(30) Foreign Application Priority Data
Dec. 21, 2010 (TW) 099144899

(51) Int. Cl. H01M 8/04; B29C 45/14

(52) U.S. Cl. 429/457; 264/254

(57) ABSTRACT

A dual-material co-injection molded bipolar plate and its manufacturing method are disclosed, in which the manufacturing method comprises the steps of: injecting a skin polymer melt containing a first conductive material into a mold cavity of a bipolar plate mold; sequential or simultaneous injecting a core polymer melt containing a second conductive and the skin polymer melt into the mold cavity; molding a bipolar plate, being a sandwich structure having a core layer packed inside a skin layer, while enabling a conductive grid composed of the first conductive material and the second conductive material to be formed between the core layer and the skin layer for improving the through-plane conductivity of the bipolar plate.

### CROSS-REFERENCE OF RELATED ART

This non-provisional application claims priority under 35 U.S.C. §119(a) on Patent Application No. 099144899 filed in Taiwan, R.O.C. on Dec. 21, 2010, the entire contents of which are hereby incorporated by reference.

### FIELD OF THE INVENTION

The present invention relates to a bipolar plate for fuel cells, and more particularly, to a dual-material co-injection molded bipolar plate with good through-plane conductivity and its manufacturing method.

### BACKGROUND OF THE INVENTION

With rapid advance of our civilization, the consumption of conventional energies, such as coal, oil and natural gases, are increasing in an alarming rate, and consequently not only the pollution to our living environment is aggravating, but also the factors causing global warning and environment deterioration, such as the greenhouse effect and acid rain, are worsening. Nowadays, it is clear that there is only a limited amount of natural energy supply available, and it will be depleted in the near future if our unrestricted use of energy continues. Accordingly, alternative energy is a primary focus for most countries in the world since it can significantly reduce the amount of toxins that are by-products of energy use without the undesirable consequences of the burning of fossil fuels, such as high carbon dioxide emissions. Among all those alternative energy sources that are developping, fuel cell stack is selected to be the most promising energy source with practical value. Comparing with conventional Internal combustion engine using fossil fuels, fuel cell stack is advantageous in its high energy conversion efficiency, little or even zero high carbon dioxide emission, low noise level, and zero fossil fuel consumption.

Generally, a fuel cell is composed of three primary components, that is, electrode, electrolyte membrane and bipolar plate, and a fuel cell stack is made by serially connecting a plurality of such single fuel cells into a battery set. Consequently, the bipolar plates are the serial-connecting conductive components in the fuel cell stack that act as an anode for one cell and a cathode for the next cell.

The bipolar plates, being an important component constructing a fuel cell stack that occupies a large proportion of the size and weight of the fuel cell stack, have a number of functions within the fuel cell stack, including: separating gases between cells; providing a conductive medium between the anode and cathode; providing a flow field channel for the reaction gases; and transferring heat out of the cell. Thus, bipolar plates require the following characteristics: good electrical conductivity, impermeable to gases, resistance to corrosion, resistance to high temperature, good mechanical properties, and so on.

Although there are some fuel cells whose bipolar plates are made of metal that have good electrical conductivity and good mechanical properties, they can be short in that: it is difficult to form microstructures on a metal bipolar plate. Therefore, with the progress of fuel cell technology, the most popular for making bipolar plate is composite materials.

There are already many researches for producing better bipolar plates. One of which is a bipolar plate manufacturing method, disclosed in TW Pat. Pub. No. 399348, which shows a bipolar plate made from a mixture of a conductive material, a resin and a hydrophilic agent that is adapted for proton exchange membrane fuel cells.

Another such research is disclosed in U.S. Pat. No. 6,248,467, which shows a bipolar plate for fuel cells consists of a molded mixture of a vinyl ester resin and graphite powder.

Moreover, there is a bipolar plate manufacturing process disclosed in TW Pat. Pub. No. 1293998, entitled “MANUFACTURING PROCESS OF HIGH PERFORMANCE CONDUCTIVE POLYMER COMPOSITE BIPOLAR PLATE FOR FUEL CELL”, in which a bipolar plate is made of a mixture of graphite powder, a vinyl ester resin and polyetheramine-intercalated organoclay.

It is noted that all the aforesaid bipolar plates are made of different composite materials that they all have the following advantages: good resistance to corrosion and easy to have complex microstructures to be formed thereon.

Since there will be heat being generated from the electrochemical reaction of a fuel cell that must be transferred out of the fuel cell for enabling the fuel cell to maintain a proper working temperature, it is required for the bipolar plates of the fuel cell to be designed with satisfactory heat dissipating ability. Conventionally, such heat dissipation is achieved by sandwiching a metal piece between two bipolar plates for enhancing heat dissipating ability of the bipolar plates. Generally, the combining of the bipolar plates and the metal piece is enabled by the use of a thermal compression process. In the thermal compression process, first, the two bipolar plates are preheated to a temperature ranged between a softening temperature and a melting temperature relating to a composite material; and then the metal piece is placed at a position between the two bipolar plates before exerting a pressure upon the structure of the two bipolar plates sandwiching the metal piece, while the whole structure is continuously being heated during the exerting of the pressure for laminating the metal piece to the two bipolar plates.

Nevertheless, since the aforesaid thermal compression process can be very time consuming that the whole process starting from the preheating to the completing of the compression may last from several minutes to several tens of minutes, it can be understood that it is possible to extremely improve the time cost performance relating to the manufacturing process. In addition, since the heating the of the whole bipolar plate structure must be continue through out the compression process, the energy cost of the manufacturing process can be a troubling issue. Hence, it is in need of an improved thermal compression process that can lower the manufacturing cost of bipolar plates.

Moreover, since the bipolar plates are acting as connectors between two fuel cells, they must be made of a material of good electrical conductivity, and it is especially important for two connecting bipolar plates to have good through-plane conductivity as it is the key issue for efficiency of the fuel cell. Thus, it is in need of a technique for manufacturing bipolar plates easily and at a low cost, but also with satisfactory through-plane conductivity

### SUMMARY OF THE INVENTION

In view of the disadvantages of prior art, the primary object of the present invention is to provide a dual-material co-injection molded bipolar plate that is ease to produce and with good through-plane conductivity, and also its manufacturing method as well.

To achieve the above object, the present invention provides a bipolar plate, comprising: a skin layer; a core layer, wrapped inside the skin layer; and a conductive grid, formed between the skin layer and the core layer.

The bipolar plate further comprises: a binding interface, formed between the skin layer and the core layer, provided for the conductive grid to embedded therein.

In addition, the present invention further provide a dual-material co-injection molding method for manufacturing bipolar plates, comprising the steps of: injecting a skin polymer melt containing a first conductive material into a mold cavity of a bipolar plate mold; sequential or simultaneous injecting a core polymer melt containing a second conductive and the skin polymer melt into the mold cavity; molding a bipolar plate, being a sandwich structure having a core layer packed inside a skin layer, while enabling a conductive grid composed of the first conductive material and the second conductive material to be formed between the core layer and the skin layer.

The aforesaid method further comprises a step of: enabling the bipolar plate mold to exert a pressure upon the skin polymer melt and the core polymer melt.

In an embodiment, the molded bipolar plate is formed with a binding interface at a position between the skin layer and the core layer so as to be provided for the conductive grid to embedded therein.

In an embodiment, the skin polymer melt is injected into the mold cavity by a specific quantity, and also the core polymer melt is injected into the mold cavity by a specific quantity.

In an embodiment, the skin polymer is substantially a polymer plastic.

In an embodiment, the first conductive material is doped into the polymer plastic, and is a material selected from the group consisting of: a material of carbon powder, a material of carbon fiber, a material of carbon nanofiber, a material of carbon nanotube, and a mixture of at least any two materials selected from the above. Moreover, the first conductive material can substantially be a non-metallic conductive filler material.

In an embodiment, the core polymer is substantially a polymer plastic.

In an embodiment, the second conductive material is doped into the polymer plastic, and is a material selected from the group consisting of: a material of metal powder, a material of carbon powder, a material of carbon fiber, a material of carbon nanofiber, a material of carbon nanotube, and a mixture of at least any two materials selected from the above. Moreover, the second conductive material can substantially be a material composed of a non-metallic conductive filler material and a metallic conductive filler material.

In an embodiment, the metallic conductive filler material is a material selected from the group consisting of: a material of metal powder, a material of metal fiber, and a mixture composed of the abovementioned two materials.

In an embodiment, the non-metallic conductive filler material is a material selected from the group consisting of: a material of carbon powder, a material of carbon fiber, a material of carbon nanofiber, a material of carbon nanotube, graphite, carbon black, graphene and a mixture of at least any two materials selected from the above.

In an embodiment, the polymer plastic is substantially a thermoplastic.

In an embodiment, the material of carbon powder is made up of a material selected from the group consisting of: graphite, carbon black, graphene and a mixture of at least any two materials selected from the above.

To sum up, as the bipolar plate of the present invention is produce utilizing the technique of dual-material co-injection molding, not only it is ease to manufacture, but also the manufacturing cost is reduced. In addition, as both the core layer and the skin layer are doped with conductive materials to be used for forming a conductive grid in the binding interface between the core layer and the skin layer, the through-plane conductivity of the resulting bipolar plate is enhanced.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a schematic diagram showing the injecting of a skin polymer melt into a mold cavity of a bipolar plate mold according to a dual-material co-injection molding method of the present invention.

FIG. 2 is a schematic diagram showing the injecting of a core polymer melt and the skin polymer melt into the mold cavity of a bipolar plate mold according to a dual-material co-injection molding method of the present invention.

FIG. 3 is a schematic diagram showing the enabling of the bipolar plate mold to exert a pressure upon the skin polymer melt and the core polymer melt that are injected inside the mold cavity of the bipolar plate mold according to a dual-material co-injection molding method of the present invention.

FIG. 4 is a schematic diagram showing the molding of a bipolar plate according to a dual-material co-injection molding method of the present invention.

FIG. 5 is a schematic diagram showing a dual-material co-injection molded bipolar plate according to the present invention.

FIG. 6 is an enlarged sectional view of the area V shown is FIG. 5.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

Please refer to FIG. 4 and FIG. 5, which are a schematic diagram showing a dual-material co-injection molded bipolar plate, and an enlarged sectional view of the area V shown is FIG. 5. In this embodiment, the bipolar plate comprises: a skin layer, made of a skin polymer A; a core layer, made of a core polymer B, being wrapping inside the skin layer for enabling the core polymer B to be surrounded by the skin polymer A, as shown in FIG. 4; a binding interface I, formed between the skin layer and the core layer while having a conductive grid embedded therein, as the area V indicated in FIG. 5.

In the present invention, the aforesaid bipolar plate is formed by a technique of double-material co-injection molding, by that it can be formed as a structure having a core layer packed inside a skin layer. Thus, the dual-material co-injection molding method for manufacturing bipolar plates comprises the steps of: using a polymer plastic doped with a first conductive material as a skin polymer; using a polymer plastic doped with a second conductive material as a core polymer; injecting a specific quantity of the skin polymer melt into a mold cavity of a bipolar plate mold; sequential or simultaneous injecting a specific quantity of the core polymer melt and the skin polymer melt into the mold cavity for molding a bipolar plate.

Thereby, the molded bipolar plate is a sandwich structure having a core layer packed inside a skin layer, while enabling a conductive grid composed of the first conductive material and the second conductive material to be formed between the core layer and the skin layer.

In an embodiment of the invention, the skin polymer can substantially be a thermoplastic; and also the core polymer can substantially be a thermoplastic.

However, if the conductive material doped in the skin polymer is a material of metal powder, the skin layer may easily be eroded when the bipolar plate is used in a fuel cell. Therefore, the first conductive material is mostly selected from materials with good corrosion resistance, such as a material of carbon powder, a material of carbon fiber, a material of carbon nanofiber, a material of carbon nanotube, or a mixture of at least any two materials selected from the above. On the other hand, the second conductive material should be a material with good electricity conductivity, such as a material of metal powder, a material of carbon powder, a material of carbon fiber, a material of carbon nanofiber, a material of carbon nanotube, or a mixture of at least any two materials selected from the above. Moreover, the aforesaid material of carbon powder can be made up of a material selected from the group consisting of: graphite, carbon black, graphene and a mixture of at least any two materials selected from the above.

In addition, the first conductive material can substantially be a non-metallic conductive filler material, and the second conductive material can substantially be a material composed of a non-metallic conductive filler material and a metallic conductive filler material. Accordingly, the non-metallic conductive filler material is a material selected from the group consisting of: a material of carbon powder, a material of carbon fiber, a material of carbon nanofiber, a material of carbon nanotube, graphite, carbon black, graphene and a mixture of at least any two materials selected from the above.

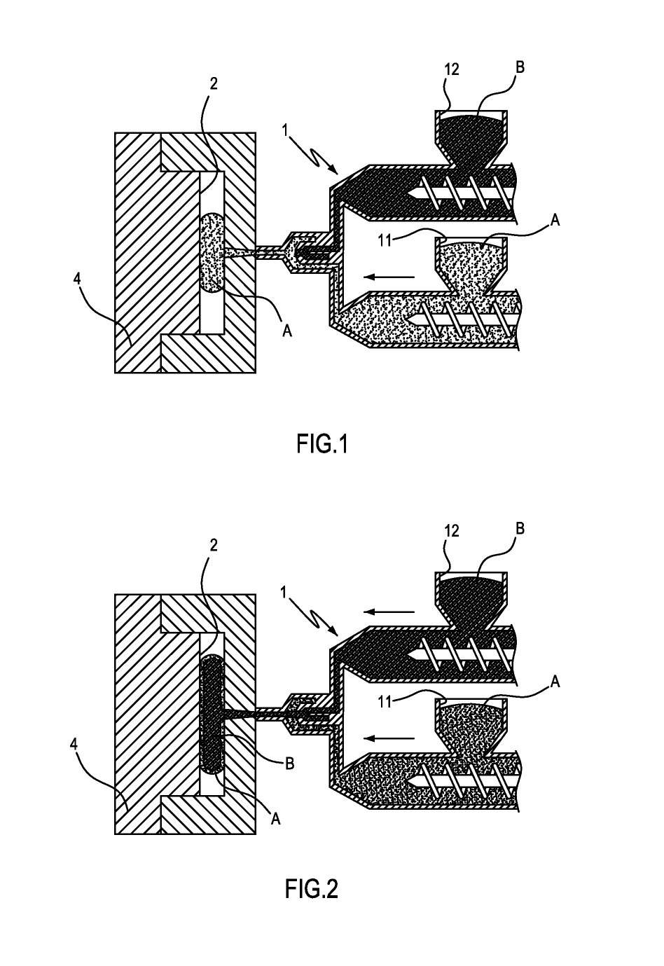

Please refer to FIG. 1 to FIG. 3, which show the sequential operation of a dual-material co-injection molding method of the present invention. In FIG. 1, a skin polymer A and a core polymer B are prepared and stored respectively inside a first feed tank 11 and a second feed tank 12 of an injection molding machine 1. Thereafter, the injection molding machine 1 will inject a specific quantity of the skin polymer melt A into a mold cavity 2 of a bipolar plate mold 4, as shown in FIG. 1.

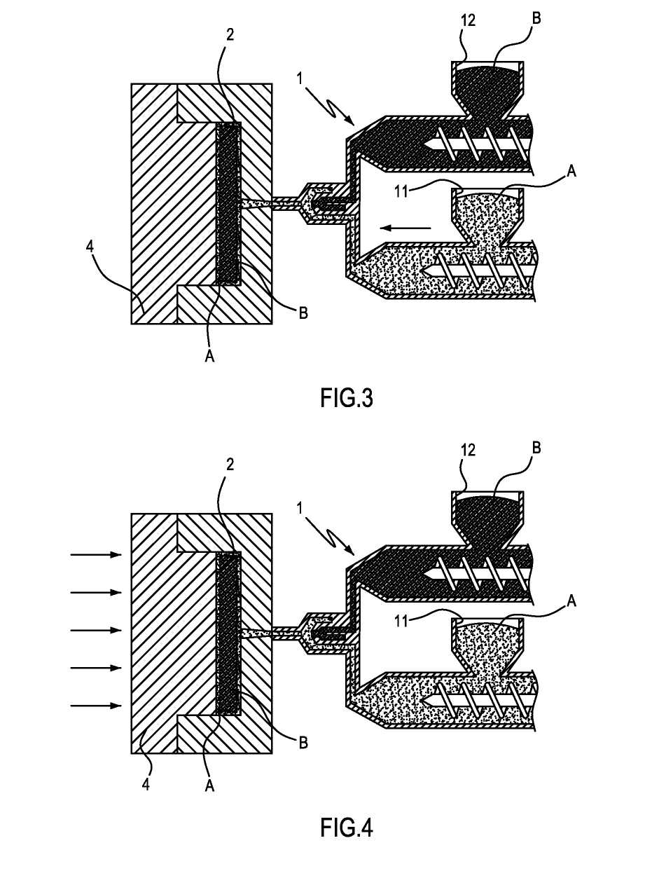

Then, as shown in FIG. 2, the injection molding machine 1 further injects a the core polymer melt and the skin polymer melt simultaneously into the mold cavity 2. Finally, the injection molding machine 1 further injects again the skin polymer melt into the mold cavity 2, as shown in FIG. 3.

In FIG. 4, the bipolar plate mold 4 is enabled to exert a pressure upon the skin polymer melt A and the core polymer melt B before the skin polymer melt A and the core polymer melt B in the mold 4 are cooled down and thus solidified. By the exerting of the pressure, the density of the conductive grid can be enhanced.

After the mold 4 is cooled down and the material therein is solidified, a bipolar plate 3 formed as a sandwich structure having a core layer packed inside a skin layer can be achieved, as the one shown in FIG. 5.

It is noted that since the bipolar plate of the present invention is manufactured by the use of a double-material co-injection molding technique, the mass production of such bipolar plate is plausible so that the manufacturing cost of the bipolar plate is reduced.

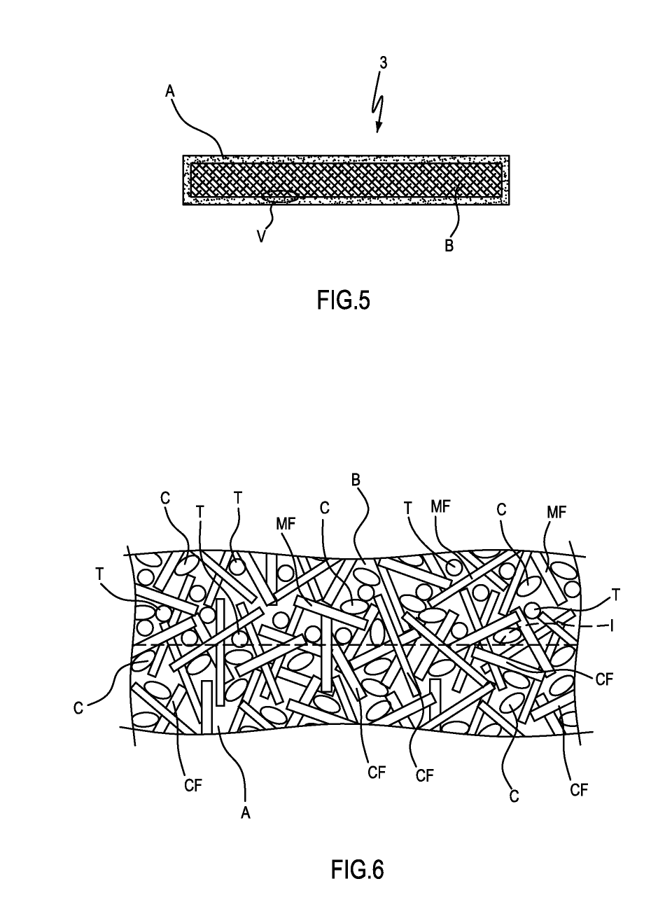

Please refer to FIG. 6, which is an enlarged sectional view of the area V shown is FIG. 5. As shown in FIG. 6, the skin polymer A and/or the core polymer B can be a material selected from the group of material that are described hereinbefore; and the binding interface I that is formed between the core layer and the skin layer in the bipolar plate is emphasized in the enlarged sectional view of FIG. 6. In this embodiment, the skin polymer A is doped with carbon fibers CF and carbon powders C while the core polymer is doped with metal fibers MF, carbon powers C and metal powers T. Thereby, when the dual-material co-injection molding method of the present invention are used for injecting the skin polymer A and the core polymer B, a conductive grid that is constructed mainly using the carbon fibers CF and the metal fibers MF will be formed in the binding interface I between the core layer and the skin layer. Moreover, as those structures of metal powers T, carbon fibers CF, metal fibers MF and carbon powers C are interconnected with each other for enhancing the density of the network in conductive grid, the through-plane conductivity of the bipolar plate can be increased effectively.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A bipolar plate, comprising:
a skin layer;
a core layer, wrapped inside the skin layer; and
a conductive grid, formed between the skin layer and the core layer.

2. The bipolar plate of claim 1, further comprising:
a binding interface, formed between the skin layer and the core layer, provided for the conductive grid to embedded therein.

3. A dual-material co-injection molding method for manufacturing bipolar plates, comprising the steps of:
injecting a skin polymer melt containing a first conductive material into a mold cavity of a bipolar plate mold;
sequential or simultaneous injecting a core polymer melt containing a second conductive and the skin polymer melt into the mold cavity; and
molding a bipolar plate, being a sandwich structure having a core layer packed inside a skin layer, while enabling a conductive grid composed of the first conductive material and the second conductive material to be formed between the core layer and the skin layer.

4. The method of claim 3, further comprising a step of:
enabling the bipolar plate mold to exert a pressure upon the skin polymer melt and the core polymer melt.

5. The method of claim 3, wherein the molded bipolar plate is formed with a binding interface at a position between the skin layer and the core layer so as to be provided for the conductive grid to embedded therein.

6. The method of claim 3, wherein the skin polymer is substantially a polymer plastic, and thus the first conductive material is doped into the polymer plastic.

7. The method of claim 6, wherein the polymer plastic is substantially a thermoplastic.

8. The method of claim 6, wherein the first conductive material is a material selected from the group consisting of: a material of carbon powder, a material of carbon fiber, a material of carbon nanofiber, a material of carbon nanotube, and a mixture of at least any two materials selected from the above.

9. The method of claim 8, wherein the material of carbon powder is made up of a material selected from the group consisting of: graphite, carbon black, graphene and a mixture of at least any two materials selected from the above.

10. The method of claim 6, wherein the first conductive material can substantially be a non-metallic conductive filler material.

11. The method of claim 10, wherein the non-metallic conductive filler material is a material selected from the group consisting of: a material of carbon powder, a material of carbon fiber, a material of carbon nanofiber, a material of carbon nanotube, graphite, carbon black, graphene and a mixture of at least any two materials selected from the above.

12. The method of claim 3, wherein the core polymer is substantially a polymer plastic, and thus the first conductive material is doped into the polymer plastic.

13. The method of claim 12, wherein the polymer plastic is substantially a thermoplastic.

14. The method of claim 12, wherein the second conductive material is a material selected from the group consisting of: a material of metal powder, a material of carbon powder, a material of carbon fiber, a material of carbon nanofiber, a material of carbon nanotube, a material of metal fiber and a mixture of at least any two materials selected from the above.

15. The method of claim 14, wherein the material of carbon powder is made up of a material selected from the group consisting of: graphite, carbon black, graphene and a mixture of at least any two materials selected from the above.

16. The method of claim 12, wherein the second conductive material can substantially be a material composed of a non-metallic conductive filler material and a metallic conductive filler material.

17. The method of claim 16, wherein the non-metallic conductive filler material is a material selected from the group consisting of: a material of carbon powder, a material of carbon fiber, a material of carbon nanofiber, a material of carbon nanotube, graphite, carbon black, graphene and a mixture of at least any two materials selected from the above; and the metallic conductive filler material is a material selected from the group consisting of: a material of metal powder, a material of metal fiber, and a mixture composed of the abovementioned two materials.

18. The method of claim 3, wherein the skin polymer melt is injected into the mold cavity by a specific quantity, and also the core polymer melt is injected into the mold cavity by a specific quantity.
